(19) United States
(12) Patent Application Publication
(10) Pub. No.: US 2018/0192033 A1
(43) Pub. Date: Jul. 5, 2018

(54) MULTI-VIEW SCENE FLOW STITCHING

(71) Applicant: Google Inc., Mountain View, CA (US)

(72) Inventors: David Gallup, Mountain View, CA (US); Johannes Schönberger, Zurich (CH)

(21) Appl. No.: 15/395,355

(22) Filed: Dec. 30, 2016

(51) Int. Cl. H04N 13/02

(52) U.S. Cl. CPC H04N 13/0242; H04N 13/0282; H04N 13/0271; H04N 13/0296

(57) ABSTRACT

A method of multi-view scene flow stitching includes capture of imagery from a three-dimensional (3D) scene by a plurality of cameras and stitching together captured imagery to generate virtual reality video that is both 360-degree panoramic and stereoscopic. The plurality of cameras capture sequences of video frames, with each camera providing a different viewpoint of the 3D scene. Each image pixel of the sequences of video frames is projected into 3D space to generate a plurality of 3D points. By optimizing for a set of synchronization parameters, stereoscopic image pairs may be generated for synthesizing views from any viewpoint. In some embodiments, the set of synchronization parameters includes a depth map for each of the plurality of video frames, a plurality of motion vectors representing movement of each one of the plurality of 3D points in 3D space over a period of time, and a set of time calibration parameters.

### BACKGROUND

### Field of the Disclosure

The present disclosure relates generally to image capture and processing and more particularly to stitching images together to generate virtual reality video.

### Description of the Related Art

Stereoscopic techniques create the illusion of depth in still or video images by simulating stereopsis, thereby enhancing depth perception through the simulation of parallax. To observe depth, two images of the same portion of a scene are required, one image which will be viewed by the left eye and the other image which will be viewed by the right eye of a user. A pair of such images, referred to as a stereoscopic image pair, thus comprises two images of a scene from two different viewpoints. The disparity in the angular difference in viewing directions of each scene point between the two images, which, when viewed simultaneously by the respective eyes, provides a perception of depth. In some stereoscopic camera systems, two cameras are used to capture a scene, each from a different point of view. The camera configuration generates two separate but overlapping views that capture the three-dimensional (3D) characteristics of elements visible in the two images captured by the two cameras.

Panoramic images having horizontally elongated fields of view, up to a full view of 360-degrees, are generated by capturing and stitching (e.g., mosaicing) multiple images together to compose a panoramic or omnidirectional image. Panoramas can be generated on an extended planar surface, on a cylindrical surface, or on a spherical surface. An omnidirectional image has a 360-degree view around a viewpoint (e.g., 360-degree panoramic). An omnidirectional stereo (ODS) system combines a stereo pair of omnidirectional images to generate a projection that is both fully 360-degree panoramic and stereoscopic. Such ODS projections are useful for generating 360-degree virtual reality (VR) videos that allow a viewer to look in any direction.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram of an omnidirectional stereo system in accordance with some embodiments.

FIG. 2 is a diagram illustrating an example embodiment of multi-view synthesis in accordance with some embodiments.

FIG. 3 is a perspective view of an alternative embodiment for multi-view synthesis in accordance with some embodiments.

FIG. 4 is a diagram illustrating temporal components in video frames in accordance with some embodiments.

FIG. 5 is a flow diagram illustrating a method of stitching omnidirectional stereo in accordance with some embodiments.

FIG. 6 is a diagram illustrating an example implementation of an electronic processing device of the omnidirectional stereo system of FIG. 1 in accordance with some embodiments.

### DETAILED DESCRIPTION

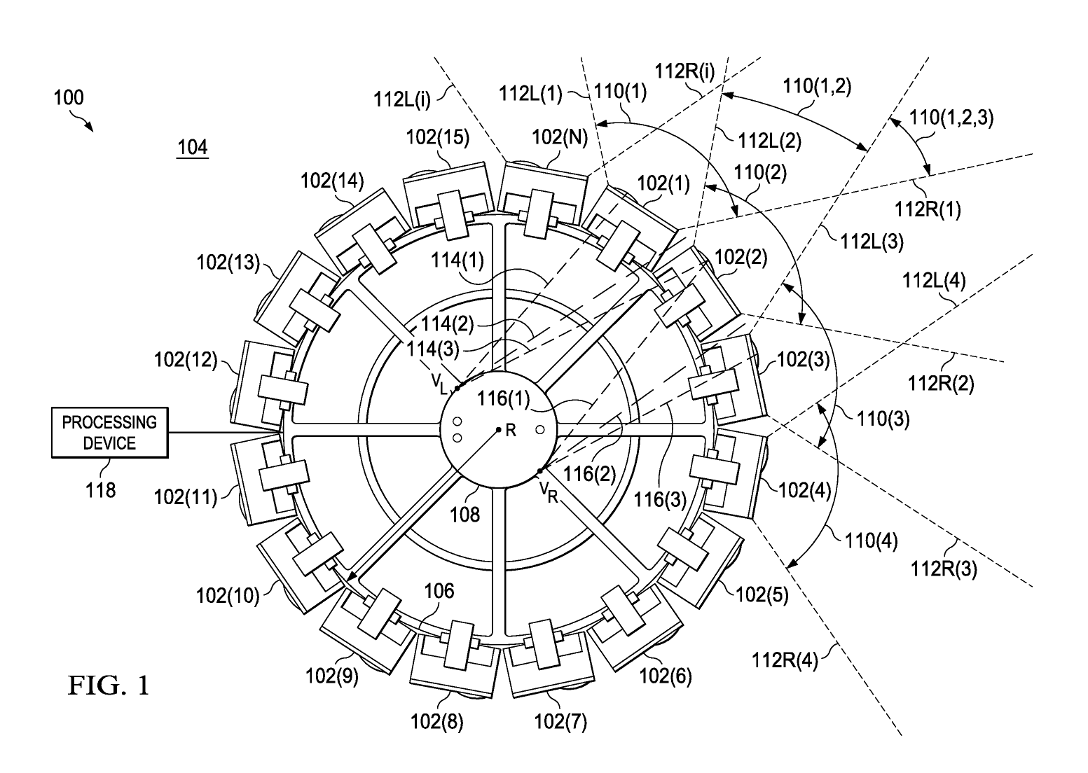

FIGS. 1-6 illustrate various techniques for the capture of multi-view imagery of a surrounding three-dimensional (3D) scene by a plurality of cameras and stitching together of imagery captured by the cameras to generate virtual reality video that is 360-degree panoramic and stereoscopic. Cameras often have overlapping fields of view such that portions of scenes can be captured by multiple cameras, each from a different viewpoint of the scene. Spatial smoothness between pixels of rendered video frames can be improved by incorporating spatial information from the multiple cameras, such as by corresponding pixels (each pixel representing a particular point in the scene) in an image to all other images from cameras that have also captured that particular point in the scene. The nature of video further introduces temporal components due to the scene changing and/or objects moving in the scene over time. Temporal information associated with video which spans time and in which objects can move should be accounted for to provide for improved temporal consistency over time. Ideally, all cameras would be synchronized so that a set of frames from the different cameras can be identified that were all taken at the same point in time. However, such fine calibration is not always feasible, leading to a time difference between image frames captured by different cameras. Further time distortions can be introduced due to the rolling shutters of some cameras.

In some embodiments, temporally coherent video may be generated by acquiring, with a plurality of cameras, a plurality of sequences of video frames. Each camera captures a sequence of video frames that provide a different viewpoint of a scene. The pixels from the video frames are projected from two-dimensional (2D) pixel coordinates in each video frame into 3D space to generate a point cloud of their positions in 3D coordinate space. A set of synchronization parameters may be optimized to determine scene flow by computing the 3D position and 3D motion for every point visible in the scene. In some embodiments, the set of synchronization parameters includes a depth map for each of the plurality of video frames, a plurality of motion vectors representing movement of each one of the plurality of 3D points in 3D space over a period of time, and a set of time calibration parameters. Based on the optimizing of synchronization parameters to determine scene flow, the scene can be rendered into any view, including ODS views used for virtual reality video. Further, the scene flow data may be used to render the scene at any time.

FIG. 1 illustrates an omnidirectional stereo (ODS) system 100 in accordance with some embodiments. The system 100 includes a plurality of cameras 102(1) through 102(N) mounted in a circular configuration and directed towards a surrounding 3D scene 104. Each camera 102(1) through 102(N) captures a sequence of images (e.g., video frames) of the scene 104 and any objects (not shown) in the scene 104. Each camera has a different viewpoint or pose (i.e., location and orientation) with respect to the scene 104. Although FIG. 1 illustrates an example implementation having sixteen cameras (that is, N=16), persons of ordinary skill in the art having benefit of the present disclosure should appreciate that the number “N” of cameras in system 100 can include any number of cameras and which may account for parameters such as each camera's horizontal field of view, radius of the circular configuration R, etc. Further, persons of ordinary skill in the art will recognize that an omnidirectional stereo system is not limited to the circular configuration described herein and various embodiments can include a different number and arrangements (e.g., cameras positioned on different planes relative to each other). For example, in an alternative embodiment, an ODS system can include a plurality of cameras mounted around a spherical housing rather than in a single-plane, circular configuration as illustrated in FIG. 1.

In some embodiments, omnidirectional stereo imaging uses circular projections, in which both a left eye image and a right eye image share the same image surface 106 (referred to as either the “image circle” or alternatively the “cylindrical image surface” due to the two-dimensional nature of images). To enable stereoscopic perception, the viewpoint of the left eye (VL) and the viewpoint of the right eye (VR) are located on opposite sides of an inner viewing circle 108 having a diameter that is approximate to the interpupillary distance between a user's eyes. Accordingly, every point on the viewing circle 108 defines both a viewpoint and a viewing direction of its own. The viewing direction is on a line tangent to the viewing circle 108. Accordingly, the radius of the circular configuration R can be selected such that rays from the cameras are tangential to the viewing circle 108. Left eye images use rays on the tangent line in the clockwise direction of the viewing circle 108 (e.g., rays 114(1)-114(3)); right eye images use rays in the counter clockwise direction (e.g., 116(1)-116(3)). The ODS projection is therefore multi-perspective, and can be conceptualized as a mosaic of images from a pair of eyes rotated 360-degrees around the viewing circle 108.

Each of the cameras 102 has a particular field of view 110(i) (where i=1 . . . N) as represented by the dashed lines 112L(i) and 112R(i) that define the outer edges of their respective fields of view. For the sake of clarity, only the fields of view 110(i) for cameras 102(1) through 102(4) are illustrated in FIG. 1. The field of view 110(i) for each camera overlaps with the field of view of at least one other camera to form a stereoscopic field of view. Images from the two cameras can be provided to the viewpoints of a viewer's eyes (e.g., images from a first camera to VL and images from a second camera to VR) as a stereoscopic pair for providing a stereoscopic view of objects in the overlapping field of view. For example, cameras 102(1) and 102(2) have a stereoscopic field of view 110(1,2) where the field of view 110(1) of camera 102(1) overlaps with the field of view 110(2) of camera 102(2). Further, the overlapping field is not restricted to being shared between only two cameras. For example, the field of view 110(1) of camera 102(1), the field of view 110(2) of camera 102(2), and the field of view 110(3) of camera 102(3) all overlap at the overlapping field of view 110(1,2,3).

Each pixel in a camera image corresponds to a ray in space and captures light that travels along that ray to the camera. Light rays from different portions of the three-dimensional scene 104 are directed to different pixel portions of 2D images captured by the cameras 102, with each of the cameras 102 capturing the 3D scene 104 visible with their respective fields of view 110(i) from a different viewpoint. Light rays captured by the cameras 102 as 2D images are tangential to the viewing circle 108. In other words, projection from the 3D scene 104 to the image surface 106 occurs along the light rays tangent to the viewing circle 108. With circular projection models, if rays of all directions from each viewpoint can be captured, a stereoscopic image pair can be provided for any viewing direction to provide for full view coverage that is both stereoscopic and covers 360-degree coverage of the scene 104. However, due to the fixed nature of the cameras 102 in the circular configuration, not all viewpoints can be captured.

In the embodiment of FIG. 1, the stereoscopic pair of images for the viewpoints VL and VR in one particular direction can be provided by rays 114(1) and 116(1), which are captured by cameras 102(1) and 102(2), respectively. Similarly, the stereoscopic pair of images for the viewpoints VL and VR in another direction can be provided by rays 114(3) and 116(3), which are captured by cameras 102(2) and 102(3), respectively. However, the stereoscopic pair of images for the viewpoints VL and VR provided by rays 114(2) and 116(2) are not captured by any of the cameras 102. Accordingly, view interpolation can be used to determine a set of correspondences and/or speed of movement of objects between images captured by two adjacent cameras to synthesize an intermediate view between the cameras. Optical flow provides information regarding how pixels from a first image move to become pixels in a second image, and can be used to generate any intermediate viewpoint between the two images. For example, view interpolation can be applied to images represented by ray 114(1) as captured by camera 102(1) and ray 114(3) as captured by camera 102(2) to synthesize an image represented by ray 114(2). Similarly, view interpolation can be applied to images represented by ray 116(1) as captured by camera 102(2) and ray 116(3) as captured by camera 102(3) to synthesize an image represented by ray 116(2). However, view interpolation based on optical flow can only be applied on a pair of images to generate views between the two cameras.

More than two cameras 102 can capture the same portion of the scene 104 due to overlapping fields of view (e.g., overlapping field of view 110(1,2,3) by cameras 102(1)-102(3)). Images captured by the third camera provides further data regarding objects in the scene 104 that cannot be taken advantage of for more accurate intermediate view synthesis, as view interpolation and optical flow is only applicable between two images. Further, view interpolation requires the cameras 102 to be positioned in a single plane, such as in the circular configuration illustrated in FIG. 1. Any intermediate views synthesized using those cameras will likewise be positioned along that same plane, thereby limiting images and/or video generated by the ODS system to three degrees of freedom (i.e., only head rotation).

In some embodiments, such as described here and further in detail with respect to FIG. 6, the ODS system 100 further includes an electronic processing device 118 communicably coupled to the cameras 102. The electronic processing device 118 generates viewpoints using multi-view synthesis (i.e., more than two images used to generate a viewpoint) by corresponding pixels (each pixel representing a particular point in the scene 104) in an image to all other images from cameras that have also captured that particular point in the scene 104. For any given view (i.e., image captured by one of the cameras 102(i)), the electronic processing device 118 determines the 3D position of that point in the scene 104. Further, the electronic processing device 118 generates a depth map that maps depth distance to each pixel for any given view. In some embodiments, the electronic processing device 118 takes the 3D position of a point in space and its depth information to back out that 3D point in space and project where that point would fall at any viewpoint in 2D space (e.g., at a viewpoint between cameras 102 along the image surface 106 or at a position that is higher/lower, backwards/forwards, or left/right of the cameras 102), thereby extending images and/or video generated by the ODS system to six degrees of freedom (i.e., both head rotation and translation).

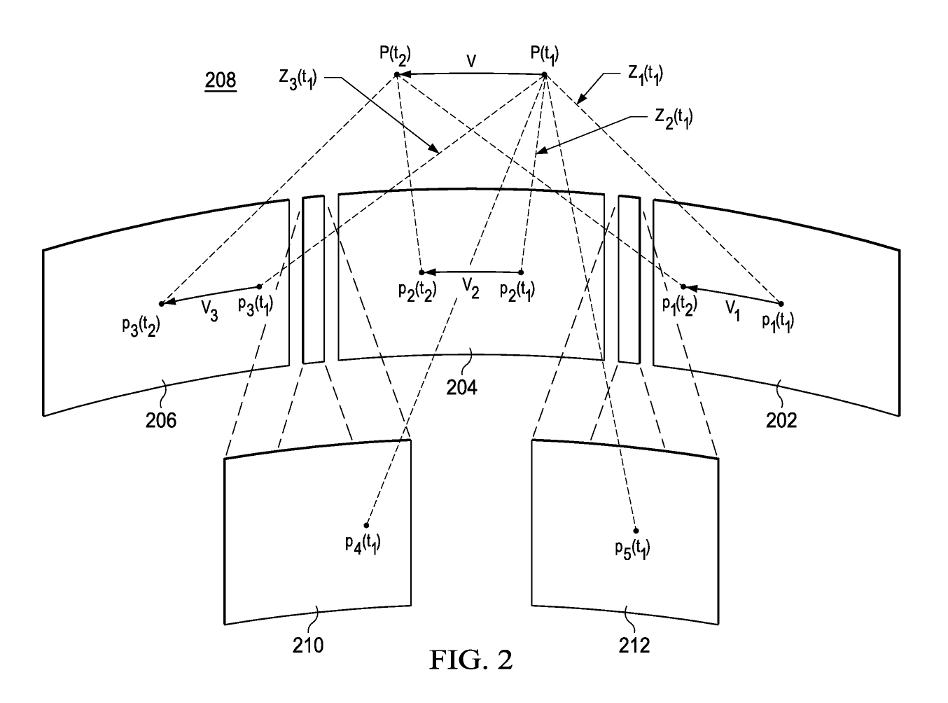

FIG. 2 is a diagram illustrating multi-view synthesis in accordance with some embodiments. Each view 202, 204, and 206 represents a different image captured by a different camera (e.g., one of the cameras 102 of FIG. 1). For each pixel in a view, the electronic processing device 118 described below with reference to FIG. 6 calculates the pixel's position in 3D space (i.e., scene point) within a scene 208, a depth value representing distance from the view to the 3D position, and a 3D motion vector representing movement of that scene point over time. As illustrated in FIG. 2, the electronic processing device 118 determines that pixel p₁(t₁) of image 202, p₂(t₁) of image 204, and p₃(t₁) of image 206 each correspond to scene point P(t₁) at a first time t₁. For a second time t₂, the position of that scene point in 3D space has shifted. Pixel p₁(t₂) of image 202, p₂(t₂) of image 204, and p₂(t₂) of image 206 each correspond to scene point P(t₂) at the second time t₂. The motion vector V represents movement of the scene point in 3D space over time from t₁ to t₂. The optical flows of pixels p₁, p₂, and p₃ in their respective views 202-206 are represented by v₁, v₂, and v₃. Although described in the context of projecting a single 2D pixel into 3D space, one of ordinary skill in the art will recognize that the disclosure described herein can be applied to all the pixels of each image to generate a 3D point cloud and further determine 3D motion fields of the 3D point cloud over time. The flow field describes 3D motion at every point in the scene over time and is generally referred to as “scene flow.”

The electronic processing device 118 generates a depth map (not shown) for each image, each generated depth map containing depth information relating to the distance between a 2D pixel (e.g., point in a scene captured as a pixel in an image) and the position of that point in 3D space. In a Cartesian coordinate system, each pixel in a depth map defines the position in the Z-axis where its corresponding image pixel will be in 3D space. In one embodiment, the electronic processing device 118 calculates depth information using stereo analysis to determine the depth of each pixel in the scene 208, as is generally known in the art. The generation of depth maps can include calculating normalized cross correlation (NCC) to create comparisons between image patches (e.g., a pixel or region of pixels in the image) and a threshold to determine whether the best depth value for a pixel has been found.

In FIG. 2, the electronic processing device 118 pairs images of the same scene as stereo pairs to create a depth map. For example, the electronic processing device 118 pairs image 202 captured at time t₁ with the image 204 captured at time t₁ to generate depth maps for their respective images. The electronic processing device 118 performs stereo analysis and determines depth information, such as the pixel p₁(t₁) of image 202 being a distance Z₁(t₁) away from corresponding scene point P(t₁) and the pixel p₂(t₁) of image 204 being a distance Z₂(t₁) away from corresponding scene point P(t₁). The electronic processing device 118 additionally pairs the image 204 captured at time t₁ with the image 206 captured at time t₁ to confirm the previously determined depth value for the pixel p₂(t₁) of image 204 and further determine depth information such as the pixel p₃(t₁) of image 206 being a distance Z₃(t₁) away from corresponding scene point P(t₁).

If the correct depth values are generated for each 2D image point of an object, projection of pixels corresponding to that 2D point out into 3D space from each of the images will land on the same object in 3D space, unless one of the views is blocked by another object. Based on that depth information, electronic processing device 118 can back project scene point P out into a synthesized image for any given viewpoint (e.g., traced from the scene point's 3D position to where that point falls within the 2D pixels of the image), generally referred to herein as “multi-view synthesis.” As illustrated in FIG. 2, electronic processing device 118 back projects scene point P(t₁) out from its position in 3D space to pixel p₄(t₁) of image 210, thus providing a different viewpoint of scene 208. Unlike images 202-206, image 210 was not captured by any cameras; electronic processing device 118 synthesizes image 210 using the 3D position of a scene point and depth values representing distance between the scene point and its corresponding pixels in the three or more images 202-206. Similarly, electronic processing device 118 electronic processing device 118 back projects scene point P(t₁) out from its position in 3D space to pixel p₅(t₁) of image 212 to synthesize a different viewpoint of scene 208. In various embodiments, the electronic processing device 118 uses one or more of the images 210 and 212 as a part or whole of a stereo pair of images to generate a stereoscopic view of the scene 208.

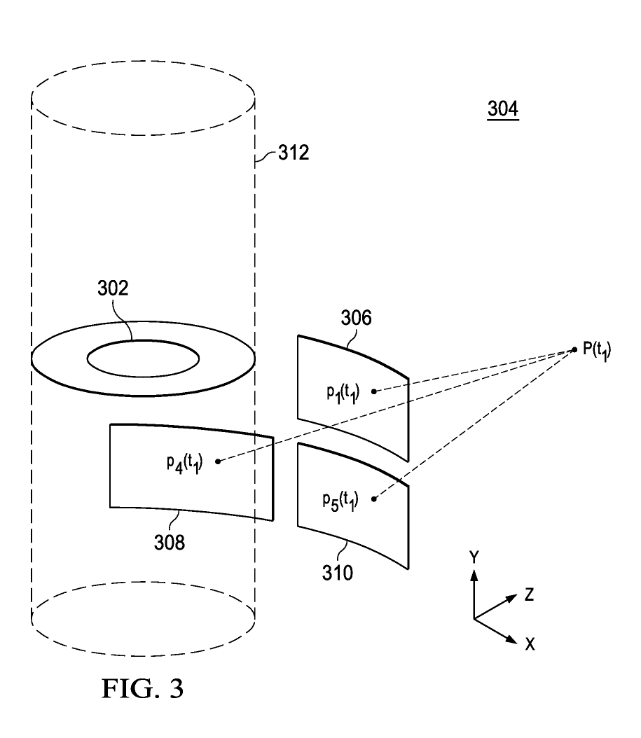

In the context of the ODS system 100 of FIG. 1, images 210 and 212 correspond to rays 114(2) and 116(2), respectively, which are not captured by any cameras. One of ordinary skill in the art will recognize that although this embodiment is described in the context of synthesizing images that share the same horizontal plane and are positioned between physical cameras along the image surface 106, other embodiments such as described further in detail with respect to FIG. 3 can include multi-view image synthesis that generates images which do not share the same horizontal plane, are tilted relative to the image surface 106, and/or are translated backwards/forwards of the cameras 102.

FIG. 3 is a perspective view of an alternative embodiment for multi-view synthesis in accordance with some embodiments. Similar to the system 100 of FIG. 1, a plurality of cameras (not shown) are mounted in a circular configuration concentric with inner viewing circle 302. Each camera is directed towards a surrounding 3D scene 304 and captures a sequence of images (e.g., video frames) of the scene 304 and any objects (not shown) in the scene 304. Each camera captures a different viewpoint or pose (i.e., location and orientation) with respect to the scene 304, with view 306 representing an image captured by one of the cameras. In one embodiment, the cameras and image 306 are horizontally co-planar with the viewing circle 302, such as described in more detail with respect to FIG. 1. Although only one image 306 is illustrated in FIG. 3 for the sake of clarity, one of ordinary skill in the art will recognize that a number of additional cameras and their corresponding views/images will also be horizontally co-planar with the viewing circle 302.

Similar to the multi-view synthesis previously described in FIG. 2, the electronic processing device 118 described below with reference to FIG. 6 determines that pixel p₁(t₁) of captured image 306, p₂(t₁) of a second captured image (not shown), and p₃(t₁) of a third captured image (not shown) each correspond to scene point P(t₁) at a first time t₁. The electronic processing device 118 generates a depth map (not shown) for each image, each generated depth map containing depth information relating to the distance between a 2D pixel (e.g., point in scene 304 captured as pixel p₁(t₁) in the image 306) and the position of that point in 3D space (e.g., scene point P(t₁)). In a Cartesian coordinate system, each pixel in a depth map defines the position in the Z-axis where its corresponding image pixel will be in 3D space. In one embodiment, the electronic processing device 118 performs stereo analysis to determine the depth of each pixel in the scene 304, as is generally known in the art.

In some embodiments, the electronic processing device 118 takes the 3D position of a point in space and its depth information to back out that 3D point in space and project where that point would fall at any viewpoint in 2D space. As illustrated in FIG. 3, the electronic processing device 118 back projects scene point P(t₁) out from its position in 3D space to pixel p₄(t₁) of image 308, thereby providing a different viewpoint of scene 304. Unlike image 306 (and the unshown second and third images), image 308 is not captured by any cameras; the electronic processing device 118 synthesizes image 308 using the 3D position of a scene point and depth values representing distance between the scene point and its corresponding pixels in the three or more images (first image 306 and unshown second/third images). Similarly, the electronic processing device 118 back projects scene point P(t₁) out from its position in 3D space to pixel p₅(t₁) of image 310 to provide a different viewpoint of scene 304. In various embodiments, the electronic processing device 118 uses one or more of the images 308 and 310 as a part or whole of a stereo pair of images to generate a stereoscopic view of the scene 304.

In contrast to the synthesized images of FIG. 2, synthesized images 308 and 310 do not share the same horizontal plane as the images from which scene point coordinates and depth maps are calculated (e.g., image 306). Rather, the electronic processing device 118 translates the synthesized images 308 and 310 vertically downwards (i.e., along y-axis) relative to the image 306. If a viewer's eyes are coincident with the viewing circle 302 while standing up straight, the electronic processing device 118 presents the synthesized images 308 and 310 to the viewer's eyes for stereoscopic viewing when the viewer, for example, crouches down. Similarly, any images synthesized using multi-view synthesis as described herein can be translated vertically upwards (i.e., along y-axis) relative to the image 306. The electronic processing device 118 presents upwardly translated images to the viewer's eyes for stereoscopic viewing when the viewer, for example, tiptoes or otherwise raises the viewer's eye level. As previously discussed with respect to FIG. 2, the electronic processing device 118 also synthesizes images that share the same horizontal plane and are translated left and/or right of the image 306 (i.e., along x-axis) to synthesize images for viewpoints that are not physically captured by any cameras. In other embodiments, the electronic processing device 118 synthesizes images that are translated backward and/or forward of the image 306 (i.e., along z-axis) to generate stereo pairs of images for viewpoints that may be forward or backward from the physical cameras that captured image 306. The electronic processing device 118 presents such images to the viewer's eyes for stereoscopic viewing when the viewer, for example, steps forward/backward and/or side-to-side. Accordingly, the limited three degrees of freedom (head rotation only) in the viewing circles of FIGS. 1-2 can be expanded to six degrees of freedom (i.e., both head rotation and translation) within the viewing cylinder 312.

The electronic processing device 118 uses image/video frame data from the images concentric with viewing circle 302 (e.g., image 306 as depicted) and depth data to project the 2D pixels out into 3D space (i.e., to generate point cloud data), as described further in relation to FIG. 2. In other words, the electronic processing device 118 synthesizes viewpoints using 3D point cloud data to allow for improved stereoscopy and parallax as the viewer yaws and/or rolls their heard or looks up and down. The point cloud represents a 3D model of the scene and can be played back frame-by-frame for viewers to not only view live-action motion that is both omnidirectional and stereoscopic, but also allows the viewer to move their head through 3D space within a limited volume such as the viewing cylinder 312.

Due to its video-based nature, the scene 304 and objects in the scene 304 change and/or move from frame to frame over time. The temporal information associated with video which spans time and in which objects can move should be accounted for to provide for improved temporal consistency over time. Ideally, all cameras (e.g., cameras 102 of FIG. 1) are synced so that a set of frames from the different cameras can be identified that were all taken at the same point in time. However, such fine calibration is not always feasible, leading to a time difference between image frames captured by different cameras. Further time distortions can be introduced due to the rolling shutters of some cameras.

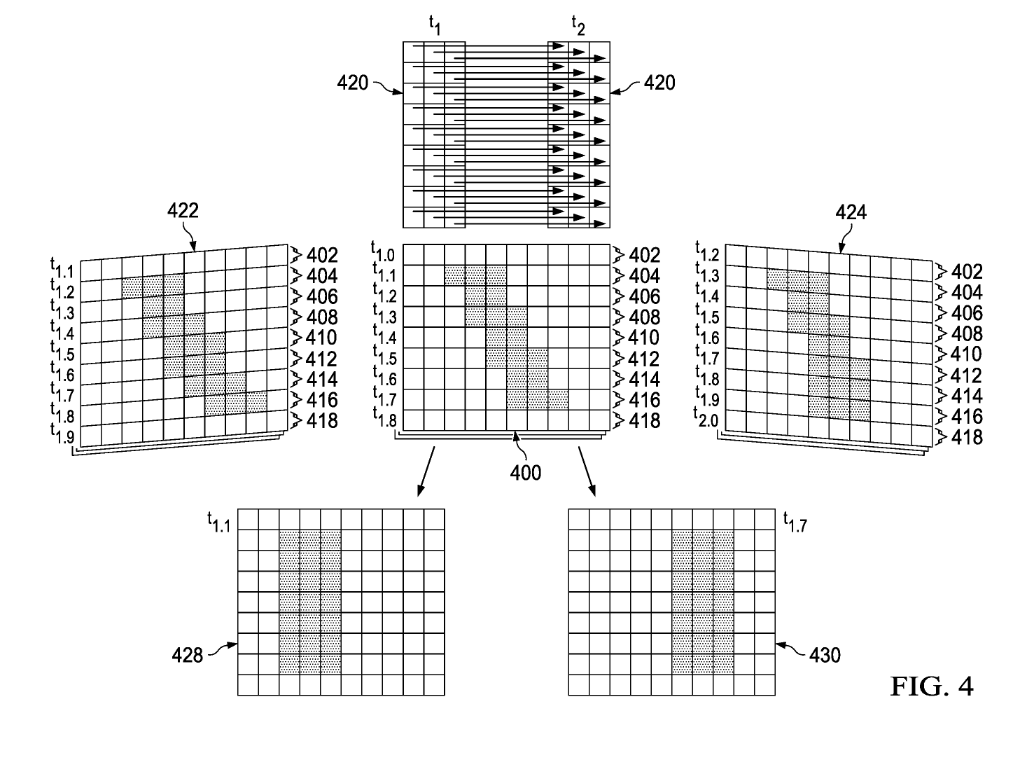

FIG. 4 is a diagram illustrating temporal components in video frames in accordance with some embodiments. One or more of the imaging cameras (e.g., cameras 102 of FIG. 1) may include rolling shutter cameras whereby the image sensor of the camera is sequentially scanned one row at a time, or a subset of rows at a time, from one side of the image sensor to the other side. In some embodiments, the image is scanned sequentially from the top to the bottom, such that the image data captured at the top of the frame is captured at a point in time different than the time at which the image data at the bottom of the frame is captured. Other embodiments can include scanning from left to right, right to left, bottom to top, etc.

For example, the cameras 102 of FIG. 1 capture each of the pixel rows 402-418 in image/video frame 400 (one of a plurality of video frames from a first viewpoint) in FIG. 4 not by taking a snapshot of an entire scene at a single instant in time but rather by scanning vertically across the scene. In other words, the cameras 102 do not capture all parts of the image frame 400 of a scene at exactly the same instant, causing distortion effects for fast-moving objects. For example, skew occurs when the imaged object bends diagonally in one direction as the object moves from one side of the image to another, and is exposed to different parts of the image 400 at different times. To illustrate, when capturing an image of object 420 that is rapidly moving from left-to-right in FIG. 4 over a time step from t₁ to t₂, a first camera of the cameras 102 captures each pixel row 402-418 in the image frame 400 at a slightly different time. That first camera captures pixel row 402 at time t₁, pixel row 404 at time t_{1.1}, and so on and so forth, with that first camera capturing final pixel row 418 at time t_{1.8}. However, due to the object's 420 speed of movement, the left edge of the object 420 shifts by three pixels to the right between times t_{1.1} to t_{1.7}, leading to the skewed view.

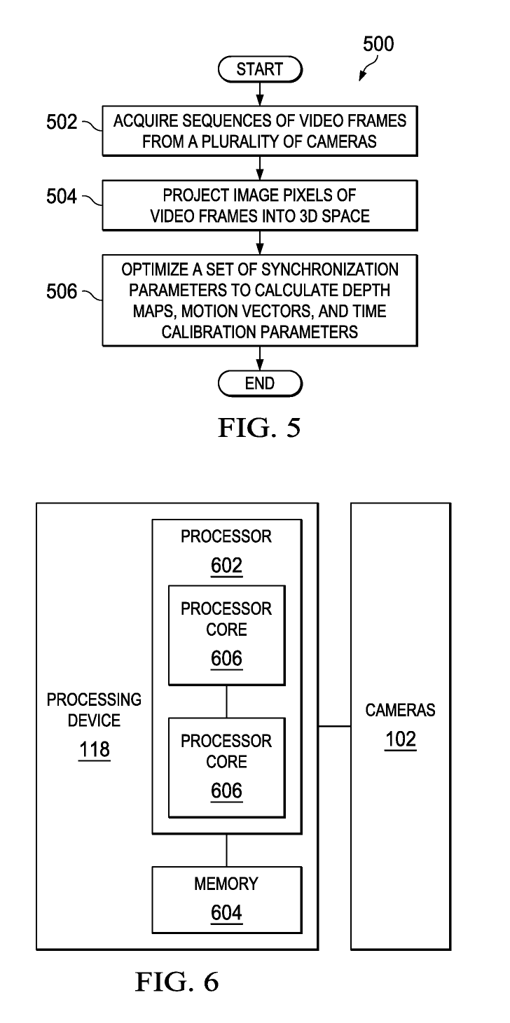

Further, in addition to pixel rows of an image (e.g., image frame 400) being captured at different times, image frames (and pixel rows) from different cameras may also be captured at different times due to a lack of exact synchronization between different cameras. To illustrate, a second camera of the cameras 102 captures pixel rows 402-418 of image frame 422 (one of a plurality of video frames from a second viewpoint) from time t_{1.1} to t_{1.9} and a third camera of the cameras 102 captures pixel rows 402-418 of image frame 424 (one of a plurality of video frames from a third viewpoint) from time t_{1.2} to t₂ in FIG. 4. Although individual pixels in different image frames (e.g., image frames 400, 422, and 424) and/or in different pixel rows 402-418 may be captured at different times, the electronic processing device 118 can apply time calibration by optimizing for rolling shutter parameters (e.g., time offset at which an image begins to be captured and the speed at which the camera scans through the pixel rows) to correct for rolling shutter effects and synchronize image pixels in time, as discussed in more detail below with respect to FIG. 5. This allows for the electronic processing device 118 to generate synchronized video data from cameras with rolling shutters and/or unsynchronized cameras.

The electronic processing device 118 synchronizes image data from the various pixel rows and plurality of video frames from the various viewpoints to compute the 3D structure of object 420 (e.g., 3D point cloud parameterization of the object in 3D space) over different time steps and further computes the scene flow, with motion vectors describing movement of those 3D points over different time steps (e.g., such as previously described in more detail with respect to FIG. 2). Based on the scene point data and motion vectors 426 that describe scene flow, the electronic processing device 118 computes the 3D position of object 420 for intermediate time steps, such as between times t₁ to t₂.

Further, the electronic processing device 118 uses the scene point and scene flow data to back project the object 420 from 3D space into 2D space for any viewpoint and/or at any time to render global shutter images. To illustrate, the electronic processing device 118 takes scene flow data (e.g., as described by motion vectors 426) to correct for rolling shutter effects by rendering a global image 428, which represents an image frame having all its pixels captured at time t_{1.1} from the first viewpoint. Similarly, the electronic processing device 118 renders a global image 430, which represents an image frame having all its pixels captured at time t_{1.7} from the first viewpoint. Although described in FIG. 4 in the context of rendering global shutter images that share the same viewpoint as physical cameras, one of ordinary skill in the art will recognize that any arbitrary viewpoint may be rendered, such as previously discussed with respect to FIG. 3.

FIG. 5 is a flow diagram illustrating a method 500 of stitching ODS video in accordance with some embodiments. The method 500 begins at block 502 by acquiring, with a plurality of cameras, a plurality of sequences of video frames. Each camera captures a sequence of video frames that provide a different viewpoint of a scene, such as described above with respect to cameras 102 of FIG. 1. In some embodiments, the plurality of cameras are mounted in a circular configuration and directed towards a surrounding 3D scene. Each camera captures a sequence of images (e.g., video frames) of the scene and any objects in the scene. In some embodiments, the plurality of cameras capture images using a rolling shutter, whereby the image sensor of the cameras are sequentially scanned one row at a time, from one side of the image sensor to the other side. The image can be scanned sequentially from the top to the bottom, such that the image data captured at the top of the frame is captured at a point in time different than the time at which the image data at the bottom of the frame is captured. Further, each one the plurality of cameras can be unsynchronized in time to each other such that there is a temporal difference between captured frames of each camera.

At block 504, the electronic processing device 118 projects each image pixel of the plurality of sequences of video frames into three-dimensional (3D) space to generate a plurality of 3D points. The electronic processing device 118 projects pixels from the video frames from two-dimensional (2D) pixel coordinates in each video frame into 3D space to generate a point cloud of their positions in 3D coordinate space, such as described in more detail with respect to FIG. 2. In some embodiments, the electronic processing device 118 projects the pixels into 3D space to generate a 3D point cloud.

At block 506, the electronic processing device 118 optimizes a set of synchronization parameters to determine scene flow by computing the 3D position and 3D motion for every point visible in the scene. The scene flow represents 3D motion fields of the 3D point cloud over time and represents 3D motion at every point in the scene. The set of synchronization parameters can include a depth map for each of the plurality of video frames, a plurality of motion vectors representing movement of each one of the plurality of 3D points in 3D space over a period of time, and a set of time calibration parameters.

In some embodiments, the electronic processing device 118 optimizes the synchronization parameters by coordinated descent to minimize an energy function. The energy function is represented using the following equation (1):

E({oⱼ},{rⱼ},{Z_{j,k}},{V_{j,k}})=Σ_{{j,k,p(m,n)∈Nphoto}}Cₚₕₒₜₒ(I_{j,k(p)},I_{m,n}(Pₘ(Uⱼ(p,Z,j,k(p),V_{j,k}(p)))))+Σ_{{j,k,(m,n)∈Nsmooth}}Cₛₘₒₒₜₕ(Z_{j,k(p)},Z_{j,m(n)})+Cₛ(V_{j,k(p)},V_{j,k(p)},V_{j,m(n)}) (1)

where Nₚₕₒₜₒ and Nₛₘₒₒₜₕ represent sets of neighboring cameras, pixels, and video frames. Cₚₕₒₜₒ and Cₛₘₒₒₜₕ represent standard photoconsistency and smoothness terms (e.g., L2 or Huber norms), respectively.

To optimize the synchronization parameters (e.g., the depth maps and the motion vectors), the electronic processing device 118 determines Cₚₕₒₜₒ such that any pixel projected to a 3D point according to the depth and motion estimates will project onto a pixel in any neighboring image with a similar pixel value. Further, the electronic processing device 118 determines Cₛₘₒₒₜₕ such that depth and motion values associated with each pixel in an image will be similar to the depth and motion values both within that image and across other images/video frames.

In equation (1), I_{j,k(p)} represents the color value of a pixel p of an image I, which was captured by a camera j at a video frame k. Z_{j,k(p)} represents the depth value of the pixel p of a depth map computed, corresponding to the image I, for the camera j at the video frame k. V_{j,k(p)} represents a 3D motion vector of the pixel p of a scene flow field for the camera j and the video frame k. P_{j(X,V)} represents the projection of a 3D point X with the 3D motion vector V into the camera j. P_{j(X)} represents a standard static-scene camera projection, equivalent to P′_{j(X,0)}. U_{j(p,z,v)} represents the projection (e.g., from a 2D pixel to a 3D point) of pixel p with depth z and 3D motion v for camera j. U_{j(p, s)} represents the standard static-scene back projection, equivalent to U′_{j(p, z, 0)}.

The camera projection term P depends on rolling shutter speed rⱼ and synchronization time offset oⱼ according to the following equation (2):

[pₓp_{y}]^{T}=P′_{j(X+(o}_{_}_{j+dt)}V) (2)

where p_{y}=dt*rⱼ and 0<=dt<1/framerate. The electronic processing device 118 solves for the time offset dt to determine when a moving 3D point is imaged by the rolling shutter. In some embodiments, the electronic processing device 118 solves for the time offset dt in closed form for purely linear cameras (i.e., cameras with no lens distortion). In other embodiments, the electronic processing device 118 solves for the time offset dt numerically as is generally known.

Similarly, the back projection term U depends on synchronization parameters according to the following equation (3):

U_{j(p, z, t)}=U′_{j(p, z)}+(oⱼ+p_{y}/rⱼ)*v (3)

In some embodiments, the electronic processing device 118 optimizes the synchronization parameters by alternately optimizing one of the depth maps for each of the plurality of video frames and the plurality of motion vectors. The electronic processing device 118 isolates the depth map and motion vector parameters to be optimized, and begins by estimating the depth map for one image. Subsequently, the electronic processing device 118 estimates the motion vectors for the 3D points associated with pixels of that image before repeating the process for another image, depth map, and its associated motion vectors. The electronic processing device 118 repeats this alternating optimization process for all the images and cameras until the energy function converges to a minimum value.

Similarly, the electronic processing device 118 optimizes the synchronization parameters by estimating rolling shutter calibration parameters of a time offset for when each of the plurality of video frames begins to be captured and a rolling shutter speed (i.e., speed at which pixel lines of each of the plurality of video frames are captured). The synchronization parameters, such as the rolling shutter speed, are free variables in the energy function. In one embodiment, the electronic processing device 118 seeds the optimization process of block 506 with an initial estimate of the synchronization parameters. For example, the rolling shutter speed may be estimated from manufacturer specifications of the cameras used to capture images (e.g., cameras 102 of FIG. 1) and the time offset between capture of each frame may be estimated based on audio synchronization between video captured from different cameras.

Similar to the coordinated descent optimization described for the depth maps and motion vectors, the electronic processing device 118 isolates one or more of the rolling shutter calibration parameters and holds all other variables constant while optimizing for the one or more rolling shutter calibration parameters. In one embodiment, seeding the optimization process of block 506 with initial estimates of the rolling shutter calibration parameters enables the electronic processing device 118 to delay optimization of such parameters until all other variables (e.g., depth maps and motion vectors) have been optimized by converging the energy function to a minimum value. In other embodiments, the electronic processing device 118 optimizes the depth map and motion vector parameters prior to optimizing the rolling shutter calibration parameters. One of ordinary skill in the art will recognize that although the embodiments are described here in the context of performing optimization via coordinated descent, any number of optimization techniques may be applied without departing from the scope of the present disclosure.

Based on the optimizing of synchronization parameters to determine scene flow, the electronic processing device 118 can render the scene from any view, including ODS views used for virtual reality video. Further, the electronic processing device 118 uses scene flow data to render views of the scene at any time that is both spatially and temporally coherent. In one embodiment, the electronic processing device 118 renders a global shutter image of a viewpoint of the scene at one point in time. In another embodiment, the electronic processing device 118 renders a stereoscopic pair of images (e.g., each one having a slightly different viewpoint of the scene) to provide stereoscopic video. The electronic processing device 118 can further stitch the images rendered together to generate ODS video.

FIG. 6 is a diagram illustrating an example hardware implementation of the electronic processing device 118 in accordance with at least some embodiments. In the depicted example, the electronic processing device 118 includes a processor 602 and a non-transitory computer readable storage medium 604 (i.e., memory 604). The processor 602 includes one or more processor cores 606. The electronic processing device 118 can be incorporated in any of a variety of electronic devices, such as a server, personal computer, tablet, set top box, gaming system, and the like. The processor 602 is generally configured to execute software that manipulate the circuitry of the processor 602 to carry out defined tasks. The memory 604 facilitates the execution of these tasks by storing data used by the processor 602. In some embodiments, the software comprises one or more sets of executable instructions stored or otherwise tangibly embodied on the non-transitory computer readable storage medium 604. The software can include the instructions and certain data that, when executed by the one or more processor cores 606, manipulate the one or more processor cores 606 to perform one or more aspects of the techniques described above. The non-transitory computer readable storage medium 604 can include, for example, a magnetic or optical disk storage device, solid state storage devices such as Flash memory, a cache, random access memory (RAM) or other non-volatile memory device or devices, and the like. The executable instructions stored on the non-transitory computer readable storage medium 604 may be in source code, assembly language code, object code, or other instruction format that is interpreted or otherwise executable by one or more processor cores 606.

The non-transitory computer readable storage medium 604 may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The non-transitory computer readable storage medium 606 may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
acquiring, with a plurality of cameras, a plurality of sequences of video frames, wherein each camera provides a different viewpoint of a scene;
projecting each image pixel of the plurality of sequences of video frames into three-dimensional (3D) space to generate a plurality of 3D points;
optimizing for a set of synchronization parameters, wherein the set of synchronization parameters includes a depth map for each of the plurality of video frames, a plurality of motion vectors representing movement of each one of the plurality of 3D points in 3D space over a period of time, and a set of time calibration parameters; and
generating, based on the optimized set of synchronization parameters, a stereoscopic image pair.

2. The method of claim 1, wherein the plurality of cameras capture images using a rolling shutter, and further wherein each one the plurality of cameras is unsynchronized in time to each other.

3. The method of claim 2, further comprising:
rendering a global shutter image of a viewpoint of the scene.

4. The method of claim 2, further comprising:
rendering a set of images from a plurality of viewpoints of the scene and stitching the set of images together to generate a virtual reality video.

5. The method of claim 1, wherein optimizing for the set of synchronization parameters includes optimizing by coordinated descent to minimize an energy function.

6. The method of claim 5, wherein optimizing for the set of synchronization parameters includes alternately optimizing one of the depth maps for each of the plurality of video frames and the plurality of motion vectors.

7. The method of claim 5, wherein optimizing for the set of synchronization parameters includes estimating rolling shutter calibration parameters of a time offset for when each of the plurality of video frames begins to be captured and a speed at which pixel lines of each of the plurality of video frames are captured.

8. A non-transitory computer readable medium embodying a set of executable instructions, the set of executable instructions to manipulate at least one processor to:
acquire, with a plurality of cameras, a plurality of sequences of video frames, wherein each camera provides a different viewpoint of a scene;
project each image pixel of the plurality of sequences of video frames into three-dimensional (3D) space to generate a plurality of 3D points;
optimize for a set of synchronization parameters, wherein the set of synchronization parameters includes a depth map for each of the plurality of video frames, a plurality of motion vectors representing movement of each one of the plurality of 3D points in 3D space over a period of time, and a set of time calibration parameters; and
generate, based on the optimized set of synchronization parameters, a stereoscopic image pair.

9. The non-transitory computer readable medium of claim 8, wherein the set of executable instructions comprise instructions to capture images using a rolling shutter, and wherein each one the plurality of cameras is unsynchronized in time to each other.

10. The non-transitory computer readable medium of claim 9, wherein the set of executable instructions further comprise instructions to: render a global shutter image of a viewpoint of the scene.

11. The non-transitory computer readable medium of claim 8, wherein the set of executable instructions further comprise instructions to: render a set of images from a plurality of viewpoints of the scene and stitch the set of images together to generate a virtual reality video.

12. The non-transitory computer readable medium of claim 8, wherein the instructions to optimize for the set of synchronization parameters further comprise instructions to optimize by coordinated descent to minimize an energy functional.

13. The non-transitory computer readable medium of claim 12, wherein the instructions to optimize for the set of synchronization parameters further comprise instructions to alternately optimize one of the depth maps for each of the plurality of video frames and the plurality of motion vectors.

14. The non-transitory computer readable medium of claim 12, wherein the instructions to optimize for the set of synchronization parameters further comprise instructions to estimate rolling shutter calibration parameters of a time offset for when each of the plurality of video frames begins to be captured and a speed at which pixel lines of each of the plurality of video frames are captured.

15. An electronic device comprising:
a plurality of cameras that each capture a plurality of sequences of video frames, wherein each camera provides a different viewpoint of a scene; and
a processor configured to:
project each image pixel of the plurality of sequences of video frames into three-dimensional (3D) space to generate a plurality of 3D points;
optimize for a set of synchronization parameters, wherein the set of synchronization parameters includes a depth map for each of the plurality of video frames, a plurality of motion vectors representing movement of each one of the plurality of 3D points in 3D space over a period of time, and a set of time calibration parameters; and
generate, based on the optimized set of synchronization parameters, a stereoscopic image pair.

16. The electronic device of claim 15, wherein the plurality of cameras capture images using a rolling shutter, and further wherein each one the plurality of cameras is unsynchronized in time to each other.

17. The electronic device of claim 15, wherein the processor is further configured to render a global shutter image of a viewpoint of the scene.

18. The electronic device of claim 15, wherein the processor is further configured to alternately optimize one of the depth maps for each of the plurality of video frames and the plurality of motion vectors.

19. The electronic device of claim 15, wherein the processor is further configured to optimize for the set of synchronization parameters by estimating rolling shutter calibration parameters of a time offset for when each of the plurality of video frames begins to be captured and a speed at which pixel lines of each of the plurality of video frames are captured.

20. The electronic device of claim 15, wherein the processor is further configured to render a set of images from a plurality of viewpoints of the scene and stitching the set of images together to generate a virtual reality video.
